(19) United States
(12) Patent Application Publication
(10) Pub. No.: US 2025/0214766 A1
(43) Pub. Date: Jul. 3, 2025

(54) MOBILE ROLL COMPACTOR FOR COMPACTING WASTE

(71) Applicant: PACKMAT EQUIPMENT, St-Jean-sur-Richelieu (CA)

(72) Inventor: Eric BOIVIN, Levis (CA)

(21) Appl. No.: 18/850,249

(22) PCT Filed: Mar. 24, 2023
(86) PCT No.: PCT/CA2023/050397

§ 371 Date: Sep. 24, 2024

Related U.S. Application Data
(60) Provisional application No. 63/323,261, filed on Mar. 24, 2022.

(51) Int. Cl. B65F 1/14

(52) U.S. Cl. CPC B65F 1/1405

(57) ABSTRACT

A mobile roll compactor for compacting waste has: a frame: a ramp connected to the frame: and a roller assembly connected to the frame. The roller assembly has: a first arm pivotally connected to the frame about a first pivot axis: a second arm pivotally connected to the first arm about a second pivot axis: a third arm having pivotally connected to the second arm about at third pivot axis: a roller rotationally connected to the third arm: an arm actuator connected to the frame and operatively connected to the first arm for selectively pivoting the first arm about the first pivot axis: and a roller actuator operatively connected to the roller for turning the roller. A method for compacting waste in an open top container with a mobile roll compactor is also disclosed.

### CROSS-REFERENCE

The present application claims priority to U.S. Provisional Patent Application No. 63/323,261, filed Mar. 24, 2022, the entirety of which is incorporated herein by reference.

### TECHNICAL FIELD

The present technology relates to mobile roll compactor for compacting waste, and more specifically to mobile roll compactors for compacting waste in open top waste containers.

### BACKGROUND

Open top waste containers are often used on constructions sites, at factories, warehouses and other businesses to receive various waste. When a container is full, it is picked up by a truck and hauled to a landfill or other waste disposal site to be emptied. The emptied container is then returned to the original site or another site to be filled again.

The costs associated with such pick-up and emptying services are typically not associated with the weight of the waste in the container. Even in cases where the weight of the waste is considered in the cost of the service, there is a portion of the cost associated with the act of picking-up and emptying the open top waste container. As such, there is an incentive for users of open top waste container to put as much waste as possible in the waste container before having it picked-up for emptying.

Mobile waste compactors have been developed to address this issue. These can be deployed to the locations of the open top waste containers and compact the waste in the containers. As such, the volume of waste in the container is reduced and more waste can then be added to the container before the container needs to be picked-up and emptied. As a result, the containers need to be picked-up less often. Although there is a cost associated with the deployment of such mobile waste compactors, since the waste containers do not need to be picked-up as often, the overall cost is reduced.

Some mobile waste compactors are referred to as mobile roll compactors. In roll compactors, a roller is connected to the end of articulated arm assembly mounted to the back of a truck. In some embodiments, one or more actuators are used to deploy the articulated arm assembly to an operational position, one or more other actuators are used to move two articulated arms of the articulated arm assembly relative to each other, and one or more other actuators are used to turn the roller and cause it to travel over the waste in the open top container to compact the waste. The high number of actuators increase the cost, complexity and weight of the roll compactor.

In other roll compactors, the articulated arm assembly has a vertical mast which allows some of the actuators to be omitted. However, these result in a roll compactor that is very high even when the roll compactor is in a transport configuration (i.e., not in use and positioned to allow the vehicle carrying the roll compactor to travel over roads).

Therefore, there is a desire for a mobile roll compactor that can overcome at least some of the above-described drawbacks.

### SUMMARY

It is an object of the present technology to ameliorate at least some of the inconveniences present in the prior art.

According to one aspect of the present technology, there is provided a mobile roll compactor for compacting waste having: a frame; a ramp connected to the frame; and a roller assembly connected to the frame. The roller assembly has: a first arm having a first end portion pivotally connected to the frame about a first pivot axis; a second arm having a first end portion pivotally connected to a second end portion of the first arm about a second pivot axis; a third arm having a first end portion pivotally connected to a second end portion of the second arm about at third pivot axis; a roller rotationally connected to a second end portion of the third arm; an arm actuator connected to the frame and operatively connected to the first arm for selectively pivoting the first arm about the first pivot axis; and a roller actuator operatively connected to the roller for turning the roller. The roller assembly has a transport configuration where the first arm is generally horizontal, and the roller is on the ramp at or near a bottom of the ramp. The roller assembly has a plurality of compacting configurations where the first arm is generally vertical and the roller is off the ramp. The roller actuator is configured to roll the roller to move the roller assembly from one compacting configuration of the plurality of compacting configurations to another compacting configuration of the plurality of compacting configurations. The roller assembly is movable from the transport configuration to one of the plurality of compacting configurations by rolling the roller up the ramp and by pivoting the first arm generally vertically. The roller actuator is configured to roll the roller along the ramp. The arm actuator is configured to pivot the first arm from horizontal to vertical.

In some embodiments, in the transport configuration the second arm rests on the frame.

In some embodiments, the roller assembly also has a stopper connected to one of the first and second arms. The stopper selectively abuts another one of the first and second arms to limit a minimum angle between the first and second arms.

In some embodiments, the roller assembly also has a stopper connected to one of the second and third arms. The stopper selectively abuts another one of the second and third arms to limit a minimum angle between the second and third arms.

In some embodiments, the roller assembly also has: a first link connected to the arm actuator; and a second link pivotally connected between the first link and the first arm. The arm actuator is configured to turn the first link to pivot the first arm.

In some embodiments, the first link is turned by the arm actuator about an axis of rotation; the second link is pivotally connected to the first link about a fourth pivot axis; the second link is pivotally connected to the first arm about a fifth pivot axis; and in the plurality of compacting configurations, the axis of rotation, the fourth pivot axis and the fifth pivot axis are aligned.

In some embodiments, the arm actuator and the roller actuator are rotary electric motors.

In some embodiments, a plurality of batteries are connected to the frame for providing electric power to the rotary electric motors.

In some embodiments, the roller has a plurality of cutters.

In some embodiments, the ramp has a track; and the roller has a sprocket for engaging the track as the roller rolls along the ramp.

In some embodiments, the track has a plurality of longitudinally spaced apart and laterally extending pins; and the sprocket has teeth for engaging the pins as the roller rolls along the ramp.

In some embodiments, the teeth of the sprocket have an asymmetrical tooth profile.

In some embodiments, the ramp is two ramps; and the first, second and third arms are laterally between the two ramps.

In some embodiments, the frame is a trailer frame of a trailer.

According to another aspect of the present technology, there is provided a method for compacting waste in an open top container with a mobile roll compactor. The mobile roll compactor has a frame, a ramp connected to the frame, a roller, and an articulated arm assembly connecting the roller to the frame. The method comprises: placing the mobile roll compactor next to the open top container; rolling the roller up the ramp, the roller being rolled by a roller actuator operatively connected to the roller for turning the roller; pivoting an arm of the articulated arm assembly from a generally horizontal position to a generally vertical position with an arm actuator, the arm having one end pivotally connected to the frame; rolling the roller off the ramp; rolling the roller over waste present in the open top container by rolling the roller with the roller actuator; pivoting the arm of the articulated arm assembly from the generally vertical position to the generally horizontal position with the arm actuator, thereby moving the roller back onto the ramp; and rolling the roller down the ramp by rolling the roller with the roller actuator.

In some embodiments, the arm is a first arm. The articulated arm assembly also has: a second arm pivotally connected to the first arm; and a third arm pivotally connected to the second arm. The roller is connected to the third arm. The second arm is pivotally connected between the first and third arms. The method further comprises: limiting a minimum angle between one of: the first and second arms; and the second and third arms; by using a stopper.

In some embodiments, limiting the minimum angle between one of: the first and second arms; and the second and third arms; is limiting the minimum angle between the first and second arms. The stopper is a first stopper connected to one of the first and second arms. The method further comprises limiting a minimum angle between the second and third arms by using a second stopper connected to one of the second and third arms.

In some embodiments, rolling the roller up the ramp comprises engaging a sprocket of the roller with a track of the ramp; and rolling the roller down the ramp comprises engaging the sprocket of the roller with the track of the ramp.

In some embodiments, the mobile roll compactor has a trailer; the frame is a trailer frame of the trailer; and placing the mobile roll compactor next to the open top container comprises backing up the trailer next to the open top container.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 10%, and preferably within 5% of the given value or range.

As used herein, the term “generally vertical” refers to an orientation that is within 15 degrees from vertical, and preferably within 10 degrees from vertical, and includes a vertical orientation. As used herein, the term “generally horizontal” refers to an orientation that is within 15 degrees from horizontal, and preferably within 10 degrees from horizontal, and includes a horizontal orientation.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

Definitions and explanations of terms provided in the present application take precedence over definitions and explanations of corresponding terms that may be found in any of the documents incorporated herein by reference.

Embodiments of the present technology each have at least one of the above-mentioned object and/or aspects, but do not necessarily have all of them. Some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front, right side of a mobile roll compactor including a trailer, with a roller assembly of the mobile roll compactor being in a transport configuration;

FIG. 2 is a right side elevation view of the mobile roll compactor of FIG. 1, with the roller assembly being in the transport configuration;

FIG. 3 is a right side elevation view of the mobile roll compactor of FIG. 1, with the roller assembly in an intermediate configuration;

FIG. 4A is a side elevation view of a portion of the roller assembly of the mobile roll compactor of FIG. 1, with the roller assembly being in the transport configuration and showing details of a stopper actuation mechanism of a stopper of the roller assembly;

FIG. 4B is a side elevation view of a portion of the roller assembly of the mobile roll compactor of FIG. 1, with the roller assembly being in an intermediate configuration and showing details of the stopper actuation mechanism of FIG. 4A;

FIG. 5 is a right side elevation view of the mobile roll compactor of FIG. 1 attached to a pick-up truck, with an open top waste container, shown in cross-section, showing the roller assembly in an intermediate configuration;

FIGS. 6 to 9 are right side elevation views of the mobile roll compactor of FIG. 1 with an open top waste container, shown in cross-section, showing the roller assembly in an intermediate configuration (FIG. 6) and in various compacting configurations (FIGS. 7 to 9) during the waste compaction process;

FIG. 10 is a right side elevation view of an alternative embodiment the mobile roll compactor of FIG. 1 mounted on a roll off truck, with an open top waste container, shown in cross-section, showing the roller assembly in an intermediate configuration; and

FIG. 11 is a right side elevation view of another alternative embodiment of the mobile roll compactor of FIG. 1 mounted on a flatbed of a truck, with an open top waste container, showing the roller assembly in the transport configuration.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

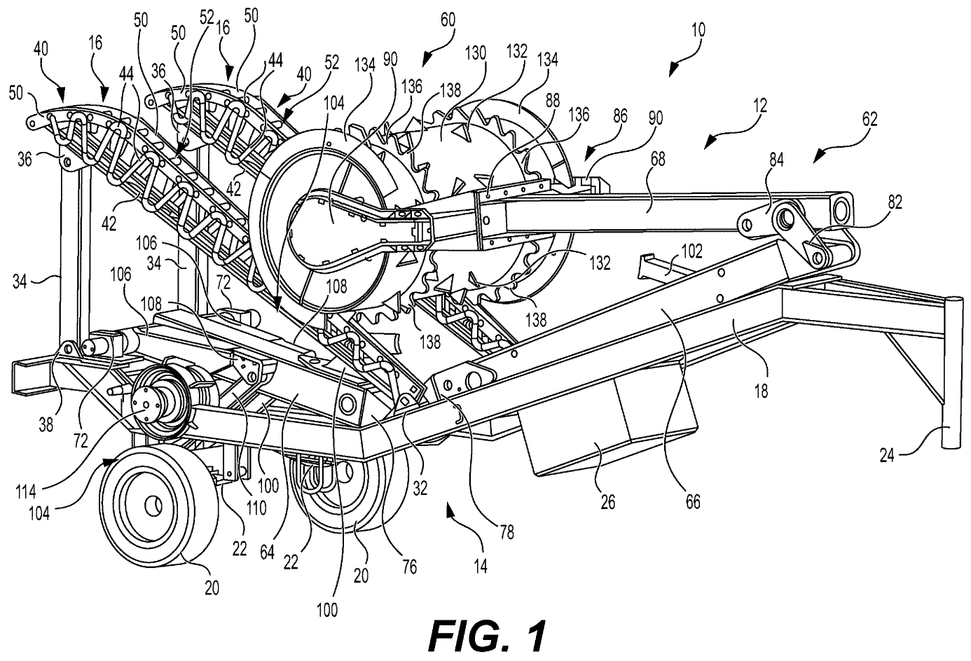

With reference to FIGS. 1 to 3, a mobile roll compactor 10 having a roller assembly 12 provided on a trailer 14 will be described. It is contemplated that the roller assembly 12 could be provided on another type of mobile platform, some of which will be described further below. In addition to the roller assembly 12 and the trailer 14, the mobile roll compactor 10 also includes a pair of ramps 16 mounted to a rear portion of the trailer 14. It is contemplated that in some embodiment, there could be only one or more than two ramps 16. The roller assembly 12, the trailer 14, and the ramps 16 will be described in more detail below. In some embodiments, the mobile roll compactor 10 weighs less than 10 000 pounds (4 536 kilograms).

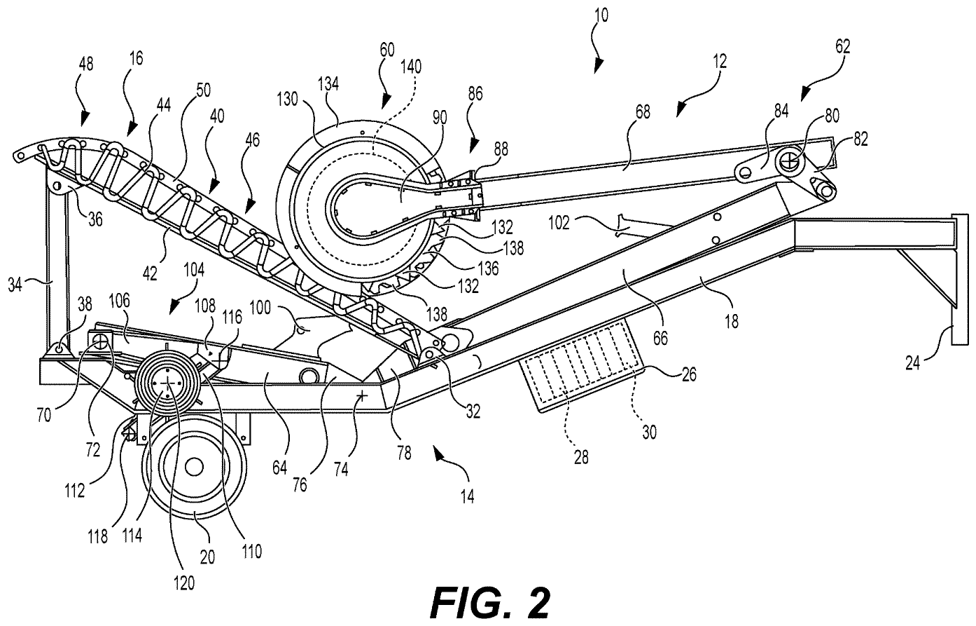

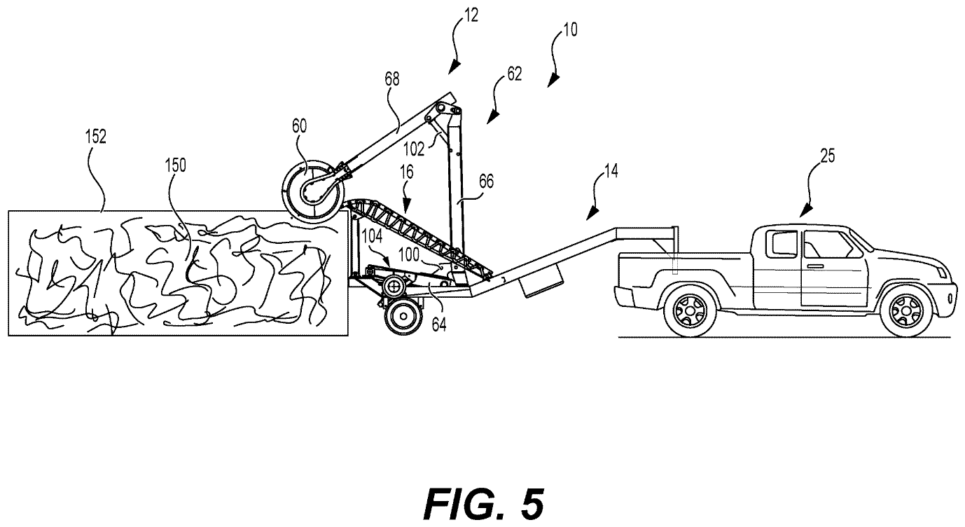

With reference to FIGS. 1 to 3, the trailer 14 has a trailer frame 18 and a pair of wheels 20 mounted to a bottom of the trailer frame 18 at a rear thereof. It is contemplated that the trailer 14 could have more than two wheels 20. The wheels 20 are mounted to the trailer frame 18 via leaf spring suspensions 22, but other types of suspensions are contemplated. The frame 18 is made from a plurality of metallic frame members that are welded to each other. It is contemplated that the frame members could be fastened to each other instead of being welded or could be connected to each other by a combination of fastening and welding, or by other means. It is contemplated that the frame members could be made from aluminum, steel, or another metal. It is also contemplated that the frame members could be made from non-metallic materials such as composite materials including aramid fibers. As can be seen, a front of the trailer frame 18 is raised. A kingpin 24 is provided at the front of the trailer frame 18 to permit pivotal connection of the trailer 14 to a vehicle. For example, as shown in FIG. 5, the trailer 14 can be connected to hitch (not shown), such as a fifth-wheel hitch, provided in a truck bed of a pick-up truck 25. In some embodiments, the trailer 14 is provided with rear reflectors and/or turn signal lights as may be required by local law in order to permit the use of the trailer 14 on public roads. The construction of the trailer 14 that is illustrated is one contemplated construction of a trailer and other constructions are contemplated. A box 26 is mounted to a bottom of an angled portion of the trailer frame 18. The box 26 contains a plurality of batteries 28 and one or more electronic controllers 30 (both shown schematically in FIG. 2). The purposes of the batteries 28 and controllers 30 will be described in more detail below.

As can be seen in FIG. 1, the two ramps 16 are laterally spaced apart from each other. As both ramps 16 are identical, on only the right ramp 16 will be described in detail. The ramp 16 has a front end connected to a central portion of the trailer frame 18 via a bracket 32. The ramp 16 has a rear end connected to the rear portion of the trailer frame 18 via a vertical member 34. A bracket 36 connects the top of the vertical member 34 to the ramp 16 and a bracket 38 connects the bottom of the vertical member 34 to the trailer frame 18. As can be seen, the rear portion of the ramp 16 is vertically higher than the front portion of the ramp 16. The ramp 16 has a track 40 connected on top of a diagonal member 42. Two undulating rods 44 connect the sides of the track 40 to the sides of the diagonal member 42. As can be seen in FIG. 2, the track 40 has a linear portion 46 that extends diagonally rearward and upward from the front end of the track 40, and an arcuate portion 48 that extends rearward and upward from the linear portion 46 and then rearward and downward to the rear end of the track 40. The track 40 has two side members 50 and laterally extending pins 52. The pins 52 are connected between the two side members 50 and are longitudinally spaced apart from each other. It is contemplated that the track 40 could have a different construction than illustrated. It is also contemplated that the ramp 16 could have a different construction than illustrated.

The roller assembly 12 includes a roller 60 and an articulated arm assembly 62 connecting the roller 60 to the trailer frame 18. The articulated arm assembly 62 has three arms 64, 66, 68. As can be seen in FIG. 1, the arms 64, 66, 68 are laterally between the two ramps 16 along a lateral center of the trailer 14. The arm 64 has an end portion pivotally connected to the trailer frame 18 about a pivot axis 70 via two pillow blocks 72. The opposite end portion of the arm 64 is pivotally connected to an end portion of the arm 66 about a pivot axis 74 via brackets 76, 78. The opposite end portion of the arm 66 is pivotally connected to an end portion of the arm 68 about a pivot axis 80 via brackets 82, 84. The opposite end portion of the arm 68 rotationally connects to the roller 60 via a roller support 86. As best seen in FIG. 1, the roller support 86 has a lateral member 88 connected to the end of the arm 68 and two legs 90 extending from the ends of the lateral member 88. The roller 60 is received between the legs 90 and is rotationally connected thereto.

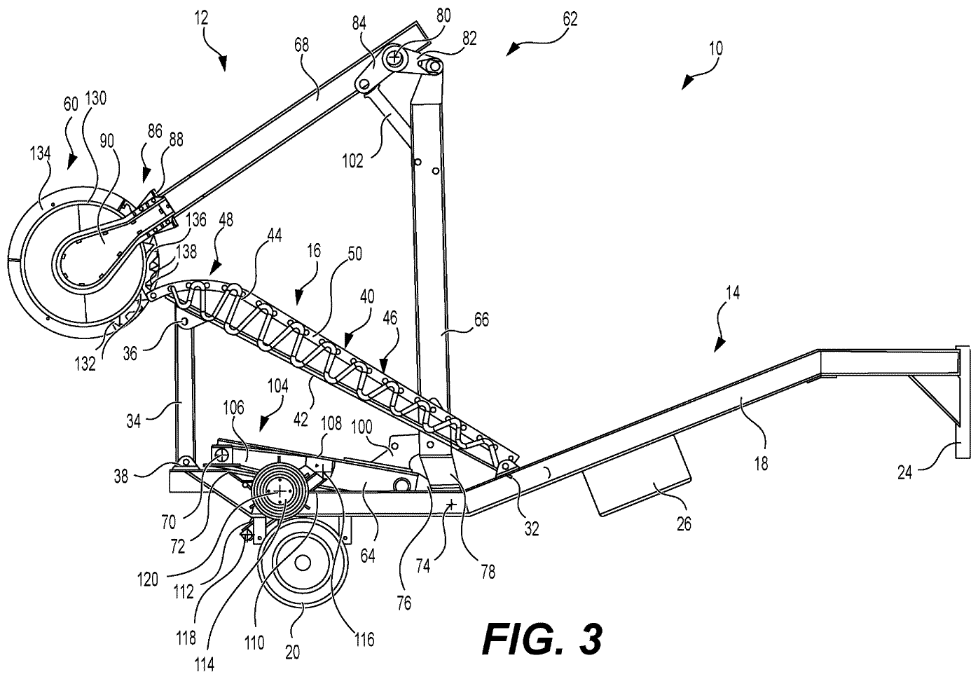

The roller assembly 12 also has two stoppers 100, 102. The stopper 100 is connected to the arm 64. The stopper 100 selectively abuts the arm 66 to limit a minimum angle between the arms 64, 66 as can be seen in FIG. 3. It is contemplated that the stopper 100 could be connected to the arm 66 to selectively abut the arm 64. In the present embodiment, when the stopper 100 abuts the arm 66, the angle between the arms 64 and 66 is about 80 degrees, but other angles are contemplated. The stopper 102 is connected to the arm 66. The stopper 102 selectively abuts the arm 68 to limit a minimum angle between the arms 66, 68 as can be seen in FIG. 3. It is contemplated that the stopper 102 could be connected to the arm 68 to selectively abut the arm 66. In the present embodiment, when the stopper 102 abuts the arm 68, the angle between the arms 66 and 68 is about 55 degrees, but other angles are contemplated. In the present embodiment, the stopper 102 is movable relative to the arm 66 as will be described in more detail below. It is contemplated that in some embodiments, the stopper 100 could be movable relative to the arm 64.

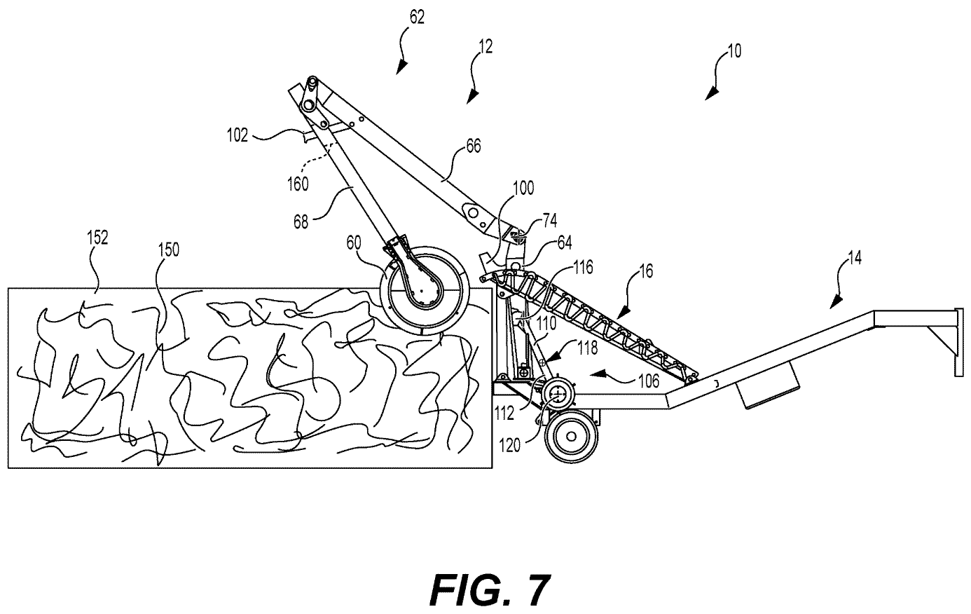

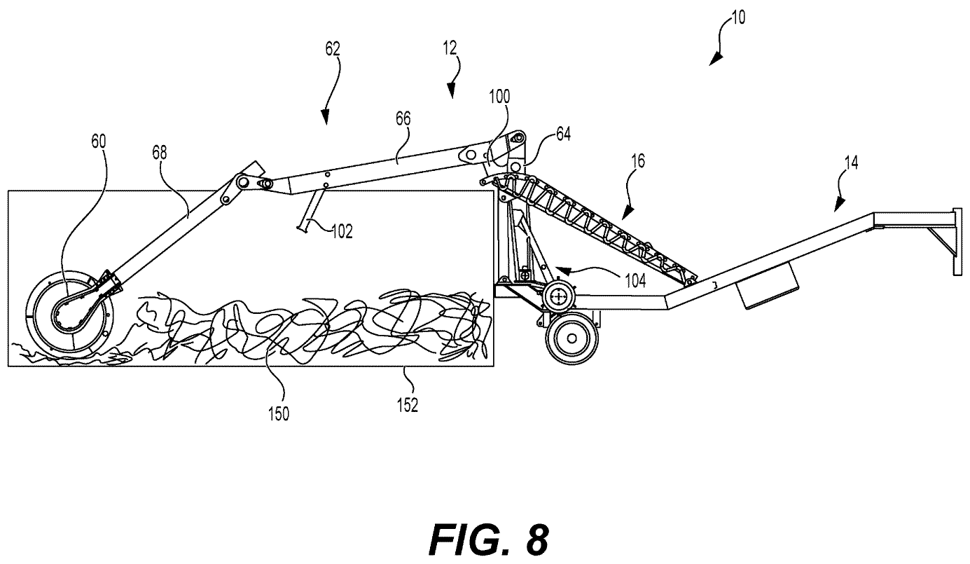

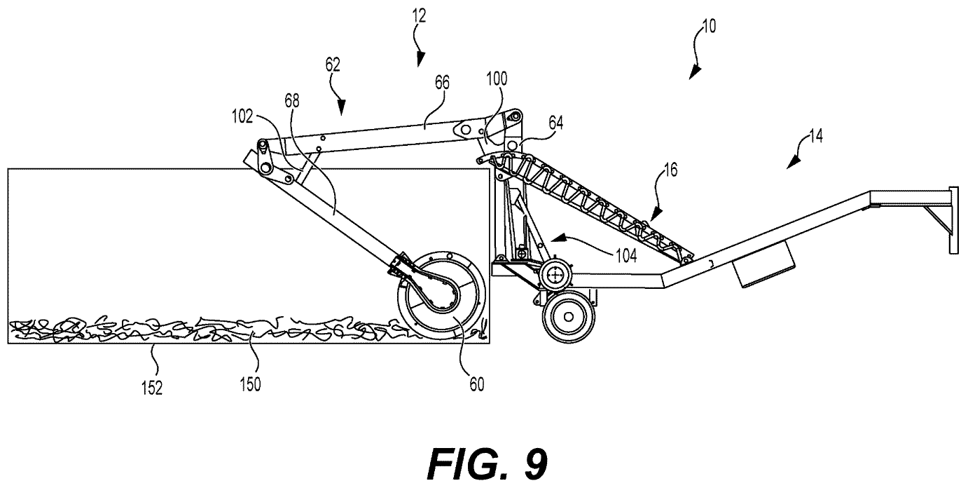

The roller assembly 12 also has two lifting assemblies 104 provided on either side of the arm 64. As the lifting assemblies 104 are mirror images of each other, only the right lifting assembly 104 will be described in detail herein. The lifting assembly 104 has an arm 106 fixedly connected to the side of the arm 64. One end of the arm 106 is pivotally connected to the trailer frame 18 about the pivot axis 70 such that the arm 106 and the arm 64 pivot together about the pivot axis 70. The other end of the arm 106 is connected to a bracket 108. The lifting assembly 104 also has two links 110, 112 and an arm actuator 114. The link 110 is pivotally connected to the bracket 108, and thereby to the arm 64, about a pivot axis 116. The link 112 has one end pivotally connected to the link 110 about a pivot axis 118. The other end of the link 112 is connected to the arm actuator 114 such that the arm actuator can turn the link 112 about an axis of rotation 120. In the present embodiment, the arm actuator 114 is a rotary electric motor 114 connected to the trailer frame 118. The link 112 is connected to an output shaft (not shown) of the rotary electric motor 114. The rotary electric motor 114 is powered by the batteries 28 and controlled by signals from the controllers 30. It is contemplated that in some embodiments, the arm actuator 114 could be of a different type, such as a hydraulic actuator for example. As will be described in more detail below, the lifting assemblies 104 are used to pivot the arm 64 between the generally horizontal position shown in FIGS. 1 and 2 and the generally vertical position shown in FIGS. 7 to 9. In the present embodiment, the arm 64 pivots by about 100 degrees between these two positions. The links 110, 112 are sized and configured such that 300 degrees of rotation of the output shaft of the rotary electric motor 114 pivots the arm 64 by 100 degrees, thereby providing a 3-to-1 mechanical advantage. Alternative embodiments of lifting assemblies 104 are contemplated. For example, gears could be used instead of links 110, 112.

With reference to FIG. 1, the roller 60 has a cylindrical drum 130 with a plurality of cutters 132 provided on its surface (only some of which are labeled). Flanges 134 are provided at either end of the drum 130. It should be noted that in FIGS. 1 to 3 part of the right flange 134 is omitted to allow some of the other features of the roller 60 to be visible. The roller 60 also has two sprockets 136 connected to the drum 130. The sprockets 136 are configured for engaging the tracks 40 of the ramps 16. More specifically, the sprockets 136 has teeth 138 (only some of which are labeled) that engage the pins 52 of the ramps 16 as the roller 60 rolls along the ramps 16 as will be described in more detail below. In the present embodiment, the teeth 138 of the sprockets 136 have an asymmetrical tooth profile, but it is contemplated that they could have a symmetrical tooth profile in other embodiments. It is also contemplated that in some embodiment, the roller 60 could have only one or more than two sprockets 136.

A roller actuator 140 is connected to the roller 60 to turn the roller 60. In the present embodiment, the roller actuator 140 is a rotary electric motor 140 disposed in part inside the drum 130 (as schematically shown in FIG. 2). The rotary electric motor 140 is connected to the drum 130 and to the legs 90 in order to rotate the roller 60. The rotary electric motor 140 is powered by the batteries 28 and controlled by signals from the controllers 30. It is contemplated that there could be two roller actuators 140 (i.e., one per leg 90). It is contemplated that in some embodiments, the roller actuator 140 could be of a different type, such as a hydraulic actuator for example. In some embodiments, cement or another heavy material is provided inside the drum 130 of the roller 60 to increase the weight of the roller 60. In some embodiments, the combined weight of the roller 60, the roller actuator 140 and the effective weight of the articulated arm assembly 62 (i.e. the weight of the articulated arm assembly 62 borne by the roller 60 during compaction) is at least 450 kilograms. This combined weight is the weight having an effect on compaction. In other embodiments, this combined weight is at least 2300 kilograms.

The roller assembly 12 has a plurality of configurations. As will be explained below, the roller assembly 12 can move from one configuration to the other by controlling the arm actuators 114 and the roller actuator 140. A remote control (not shown) wirelessly communicates with the controllers 30. The controllers 30 control the speed and direction of rotation of the arm actuators 114 and of the roller actuator 140 based on the signals received from the remote control. It is contemplated that instead of or in addition to the remote control, input devices could be provided directly on the mobile roll compactor 10 to send signals to the controllers 30 to control the speed and direction of rotation of the arm actuators 114 and of the roller actuator 140 via wired connections. The input devices could be buttons, switches and/or levers. It is also contemplated that the mobile roll compactor 10 could be provided with sensors and/or cameras communicating with the controllers 30 to provide automated or semi-automated operation of the arm actuators 114 and of the roller actuator 140.

The roller assembly 12 has a transport configuration which is shown in FIGS. 1 and 2. As can be seen, in the transport configuration the arm 64 is generally horizontal, the arm 66 rests on the trailer frame 18, and the roller 60 is on the ramps 16 at a roller position that is near a bottom of the ramps 16. It is contemplated that in some embodiments, the roller 60 could be at the bottom of the ramps 16 when the roller assembly 12 is in the transport configuration. In the transport configuration, the stopper 100 does not abut the arm 66 and the stopper 102 does not abut the arm 68. As the arm 66 rests on the trailer frame 18 and the roller 60 is on the ramps 16, the forces transferred to the arm actuators 114 as the trailer 14 goes over bumps and holes during transportation are minimized.

The roller assembly 12 has a plurality of compacting configurations some of which are shown in FIGS. 7 to 9. In all compacting configurations, the arm 64 is generally vertical and the roller 60 is off the ramps 16. The arm actuators 114 are configured to pivot the arm 64 between horizontal and vertical to move the roller assembly 12 to the compacting configurations. The roller actuator 140 is configured to roll the roller 60 over waste 150 in an open top container 152 to move the roller assembly 12 from one compacting configuration to another to compact the waste 150 as will be described below. As the roller 60 is rolled over waste 150, the arms 66, 68 move to follow the roller 60 and the arm 64 remains generally vertical. With reference to FIG. 7, in the compacting configurations, for each of the lifting assemblies 104, the pivot axis 116, the pivot axis 118 and the axis of rotation 120 are aligned. As such, forces applied to the arm 64 at the pivot point 74 as a result of the roller 60 rolling over waste 150 do not apply torque about the axis of rotation 120 to the output shafts of the arm actuators 114 which can help in preventing damage to the arm actuators 114.

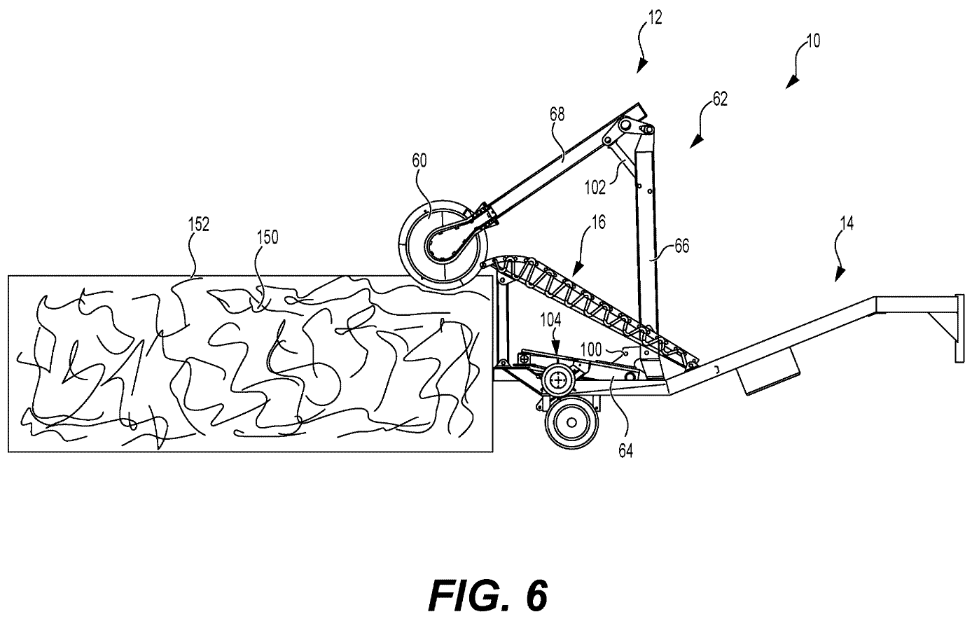

The roller assembly 12 has plurality of intermediate configurations, one of which is shown in FIGS. 3 and 6. As can be seen, in the intermediate configuration shown in FIGS. 3 and 6, the arm 64 is has pivoted up compared to its position in the transport configuration but is still generally horizontal, the arm 66 is generally vertical, and the roller 60 is on the ramps 66 at a roller position near a top of the ramps 16. More specifically, the roller 60 is only in contact with the rearmost pins 52 of the ramps 16. In embodiments where the ramps 16 only extend diagonally linearly, the roller 60 is at the top of the ramps 16 when the roller 60 is at the rear end of the ramps 16. The roller actuator 140 is configured to roll the roller 60 along the ramps 16 between the position shown in FIGS. 1 and 2 and the position shown in FIGS. 3 and 6. In the present embodiment, the arm actuators 114 are not used to move the roller assembly 12 between the transport configuration and the intermediate configuration shown in FIGS. 3 and 6. It is contemplated that in some alternative embodiment, the arm actuators 114 are not used to move the roller assembly 12 between the transport configuration and an intermediate configuration where the roller 60 is at the peaks of the arcuate portions 48 of the tracks 40 of the ramps 16, and the arm actuators 114 pivot the arm 64 up as the roller 60 moves from the peaks of the arcuate portions 48 of the tracks 40 of the ramps 16 to the position shown in FIGS. 3 and 6. As the roller actuator 140 turns the roller 60, the teeth 138 of the sprockets 136 engage the pins 52 of the ramps 16 to make the roller 60 climb the ramps 16 or to control the descent of the roller 60 down the ramps 16 depending on the direction of rotation of the roller 60. In the intermediate configuration shown in FIGS. 3 and 6, the stopper 100 abuts the arm 66 and the stopper 102 abuts the arm 68. It is contemplated that the roller 60 could be stopped at any position along the ramps 16.

It is contemplated that the mobile roll compactor 10 could be provided with outriggers that are deployed prior to using the mobile roll compactor 10 to compact waste to stabilize the trailer 14 and take weight off the wheels 20. Such outriggers could be deployed manually or automatically. For example, the outriggers could be automatically deployed by the arm actuators 114 as the arm actuators 114 move the arm 64 from its generally horizontal position to its generally vertical position.

A method for compacting waste 150 in the open top container 152 with the mobile roll compactor 10 will be described. The open top container 152 has four lateral sides and a bottom. The top of the container 152 is open, hence the name open top container 152. It is contemplated that the open top container 152 could have a lid to selectively close the top of the open top container 152. As such, for purposes of the present application, an open top container 152 is a container which has a top that is permanently open or selectively open. The maximum width of the roller support 86 is narrowed than an inside width of the open top container 152.

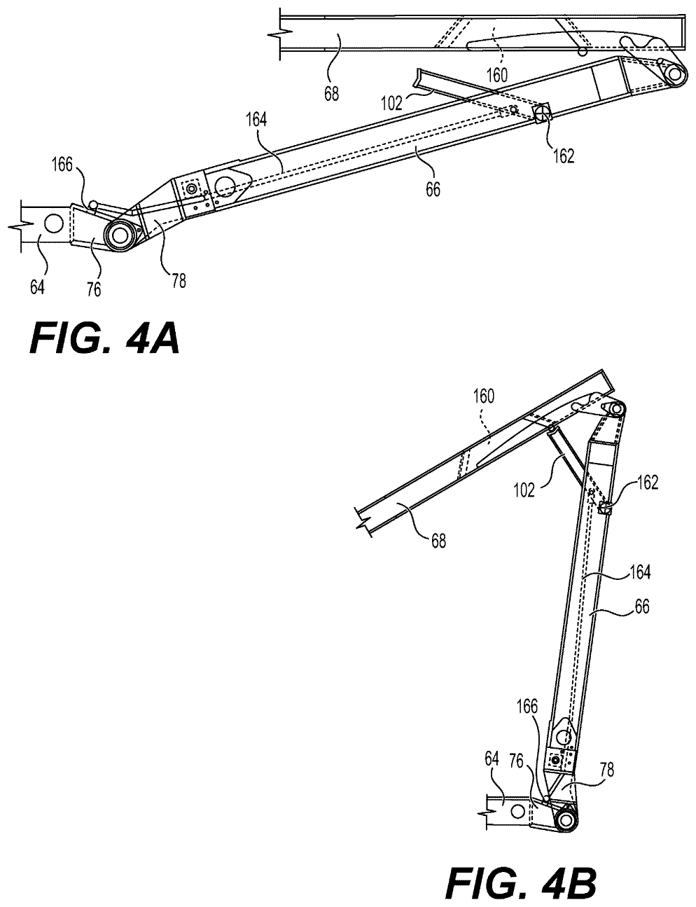

The mobile roll compactor 10 is first placed next to the open top container 152. This is done by backing up the trailer 14 next to the open top container 102 as shown in FIGS. 5 and 6, but with the roller assembly 12 in the transport configuration. As can be seen, the rear ends of the ramps 16 are vertically higher than a top of the open top container 152. Then the roller 60 is rolled up the ramps 16 by the roller actuator 140 such that the roller 60 passes over the top of the open top container 152 and then moves down partially into the open top container 152, thereby placing the roller assembly in the deployed configuration as shown in FIG. 4. The arm 64 is then pivoted from the generally horizontal position shown in FIGS. 3 and 6 to the generally vertical position shown in FIG. 7 by the arm actuators 114. As a result, the roller 60 rolls off the ramps 16 and into the open top container 152 on top of the waste 150 into a compacting configuration. The roller 60 is then rolled back and forth over the waste 150 present in the open top container 152, using the roller actuator 140. With each pass of the roller 60, the waste 150 gets gradually more and more compacted under the weight of the roller 60 as can be seen by comparing FIGS. 7 to 9. In FIGS. 6 to 9, the waste 150 is shown as being extremely compressible to show that the roller assembly 12 is configured such that the roller 60 can reach almost all areas in the open top container 152 from front to back and top to bottom. Depending on the type of waste 150, with the container 152 being initially full, it may only be possible to compact the waste 150 by 50 percent of its initial volume, or less than 75 percent of its initial volume. Once the waste 150 is compacted, the arm 64 is pivoted from the generally vertical position back to the generally horizontal position with the arm actuators 114, thereby moving the roller 60 back onto the ramps 16 and into the position shown in FIG. 6. The roller 60 is then rolled down the ramps 16 using the roller actuator 140 to put the roller assembly 12 back in the transport configuration shown in FIGS. 1 and 2. The mobile roll compactor 10 can then be driven off to the next open top container 152 that requires the waste 150 contained therein to be compacted.

As described above, the stoppers 100, 102 selectively abut the arms 66, 68 respectively. These abutments are desirable in some configurations of the articulated arm assembly 62 but not in others. With reference to FIGS. 3 and 6, when moving the roller 60 on and off the ramps 16, the stoppers 100, 102 abut the arms 66, 68 respectively to limit a minimum angle between the arms 64, 66 and between the arms 66, 68, thus allowing the roller 60 to clear the top of the side of the open top container 152, without requiring powered actuators connected between the arms 64, 66 and between the arms 66, 68 for moving these arm relative to each other. However, in the transport configuration, it is desirable for the stopper 102 to not come in contact with the arm 68, as shown in FIG. 2, such that the arm 68 can be as close as possible to the arm 66 in order to minimize the overall height of the mobile roll compactor 10 during transport. As such, the stopper 102 is moved relative to the arm 66 so as not to contact the arm 68. Also, there are some compacting configurations, such as the one shown in FIG. 7, where the angle between the arms 66, 68 needs to be small in order to reach an area in the container 152. In such compacting configurations, the stopper 102 is moved relative to the arm 66 so as to pass through an aperture 160 (shown in dotted lines in FIGS. 4A, 4B) defined in the arm 68, thus allowing the arm 68 to pivot close to the arm 66 without abutting the stopper 102.

With reference to FIGS. 4A and 4B, in the present embodiment, the stopper 102 is pivotally connected to the arm 66 about a pivot axis 162. The stopper 102 is moved relative to the arm 66 by a linkage 164 disposed in part inside the arm 66. As can be seen, the linkage 164 has a bend. The linkage 164 is pivotally connected to the stopper at one end and to the arm 64 at the other end. More specifically, the linkage 164 is pivotally connected to a bracket 166 that is connected to the bracket 76 which connects to the arm 64. The linkage 164 controls a position of the stopper 102 in response to a position of the arm 66 relative to the trailer arm 64. When the angle between the arms 64 and 66 is greater than a predetermined angle, such as in the transport configuration as shown in FIG. 4A, the linkage 164 moves the stopper 102 to a position where the stopper 102 will not abut the arm 68. When the angle between the arms 64, 66 is less than the predetermined angle, such as in the intermediate configuration shown in FIG. 4B, the linkage 164 moves the stopper 102 to a position where the stopper 102 will eventually abut the arm 68 as the arm 68 pivots toward the arm 66. For at least some angles between the arms 64, 66 that are between the angles shown in FIGS. 4A and 4B, the linkage 164 moves the stopper 102 to positions where the stopper 102 will eventually be received in the aperture 160 as the arm 68 pivots toward the arm 66. In the present embodiment, this predetermined angle is about 95 degrees, but other angles are contemplated. It should be noted that in FIGS. 4A and 4B, the stopper 100 has been omitted so as to not interfere with the illustration of the linkage 164.

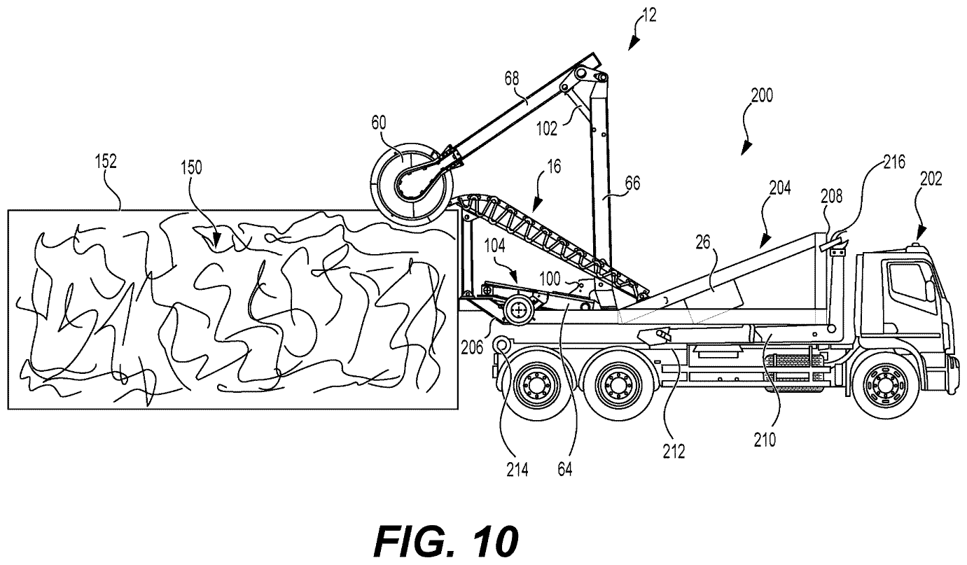

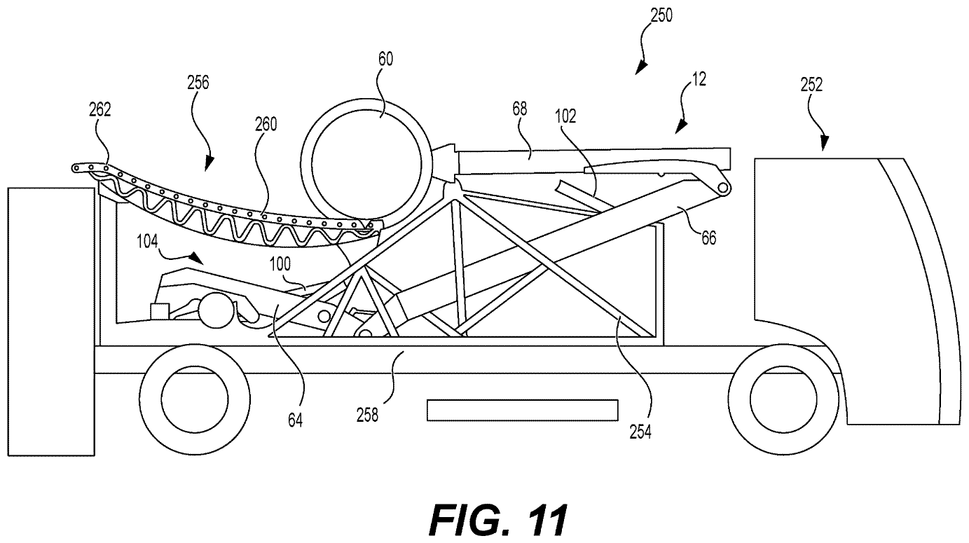

Turning now to FIGS. 10 and 11, two alternative embodiments of the mobile roll compactor 10 will be described. For simplicity, elements of these two alternative embodiment that are similar to those of the mobile roll compactor 10 will not be described again in detail.

FIG. 10 shows a mobile roll compactor 200 provided on a roll off truck 202. The mobile roll compactor 200 is the same as the mobile roll compactor 10 except that the trailer frame 18 has been replaced by a support frame 204. The support frame 204 has wheels 206 at its rear and a coupling bar 208 at its front. The roll off truck 202 has a pivoting loading frame 210 pivotally connected to the flatbed 212 of the truck 202, and roller 214 rotationally connected to the back of the flatbed 212. The loading frame 210 has a hook 216. In this embodiment, the mobile roll compactor 200 can be placed on the ground when not in use allowing the roll off truck 202 to be used for other things, such as transporting containers like the open top container 152.

With the mobile roll compactor 200 on the ground, the roll off truck 202 can back up neat the mobile roll compactor 200. The loading frame 210 is then pivoted rearward and the hook 216 is hooked onto the coupling bar 208 of the support frame 204. The loading frame 210 is then pivoted back forward, thereby pulling the mobile roll compactor 200 onto the roll off truck 200. The loading frame 210 and the hook 216 secure the mobile roll compactor 200 to the roll off truck 202. The roll off truck 202 can then drive around and move next to open top containers, such as the open top container 152, to use the mobile roll compactor 200 to compact waste 150 in the same manner as the one described above with respect to the mobile roll compactor 10. To remove the mobile roll compactor 200 from the truck 202, the loading frame 210 is pivoted rearward, thereby making the mobile roll compactor 200 move off the flatbed 212. Once the mobile roll compactor 200 is on the ground, the hook 216 is disengaged from the coupling bar 200 and the loading frame 210 is then pivoted back forward. Additional details regarding a roll off truck 202 and the loading and unloading of a roll compactor thereon are described in U.S. Pat. No. 7,100,500 B2, issued Sep. 5, 2006, the entirety of which is incorporated herein by reference.

FIG. 11 shows a mobile roll compactor 250 provided on a flatbed truck 252. The mobile roll compactor 250 is the same as the mobile roll compactor 10 except that the trailer frame 18 has been replaced by a support frame 254 and the ramps 16 have been replaced by ramps 256. The support frame 254 is fixed to the flatbed 258 of the flatbed truck 252. Although the structure of the support frame 254 differs from that of the trailer frame 18, the support frame 254 is nonetheless configured to allow the arm 66 to rest thereon on the transport configuration, as show in FIG. 11. The ramps 256 are less inclined than the ramps 16. Also, instead of having linear portions 46 followed by arcuate portions 48 like the ramps 16, the ramps 256 each have a concave arcuate portions 260 followed by a convex arcuate portion 262. It is contemplated that he mobile roll compactor 250 could be provided with the ramps 16 instead of the ramps 256. It is also contemplated that the mobile roll compactors 10 and 200 could be provided with the ramps 256 instead of the ramps 16. In the present embodiment, the flatbed truck 252 is an electric vehicle with batteries (not shown) provided below the flatbed 258. As such, in this embodiment the mobile roll compactor 250 does not have a box 26 containing batteries 28 and controllers 30. The arm actuators 114 and the roller actuator 140 are powered by the batteries of the flatbed truck 252 and controlled by controllers provided in the flatbed truck 252. It is contemplated that in embodiments where the flatbed truck 252 is not an electric vehicle, batteries could be provided on the flatbed 258 to power the arm actuators 114 and the roller actuator 140. The flatbed truck 252 can drive around and move next to open top containers, such as the open top container 152, to use the mobile roll compactor 250 to compact waste 150 in the same manner as the one described above with respect to the mobile roll compactor 10.

Modifications and improvements to the above-described embodiments of the present invention may become apparent to those skilled in the art. The foregoing description is intended to be exemplary rather than limiting. The scope of the present invention is therefore intended to be limited solely by the appended claims.

What is claimed is:

1. A mobile roll compactor for compacting waste comprising:
a frame;
a ramp connected to the frame; and
a roller assembly connected to the frame, the roller assembly comprising:
a first arm having a first end portion pivotally connected to the frame about a first pivot axis;
a second arm having a first end portion pivotally connected to a second end portion of the first arm about a second pivot axis;
a third arm having a first end portion pivotally connected to a second end portion of the second arm about at third pivot axis;
a roller rotationally connected to a second end portion of the third arm;
an arm actuator connected to the frame and operatively connected to the first arm for selectively pivoting the first arm about the first pivot axis; and
a roller actuator operatively connected to the roller for turning the roller;
the roller assembly having a transport configuration where the first arm is generally horizontal, and the roller is on the ramp at or near a bottom of the ramp;
the roller assembly having a plurality of compacting configurations where the first arm is generally vertical and the roller is off the ramp, the roller actuator being configured to roll the roller to move the roller assembly from one compacting configuration of the plurality of compacting configurations to another compacting configuration of the plurality of compacting configurations; and
the roller assembly being movable from the transport configuration to one of the plurality of compacting configurations by rolling the roller up the ramp and by pivoting the first arm generally vertically, the roller actuator being configured to roll the roller along the ramp, and the arm actuator being configured to pivot the first arm from horizontal to vertical.

2. The mobile roll compactor of claim 1, wherein in the transport configuration the second arm rests on the frame.

3. The mobile roll compactor of claim 1 or 2, wherein the roller assembly further comprises a stopper connected to one of the first and second arms, the stopper selectively abutting another one of the first and second arms to limit a minimum angle between the first and second arms.

4. The mobile roll compactor of any one of claims 1 to 3, wherein the roller assembly further comprises a stopper connected to one of the second and third arms, the stopper selectively abutting another one of the second and third arms to limit a minimum angle between the second and third arms.

5. The mobile roll compactor of any one of claims 1 to 4, wherein the roller assembly further comprises:
a first link connected to the arm actuator; and
a second link pivotally connected between the first link and the first arm;
wherein the arm actuator is configured to turn the first link to pivot the first arm.

6. The mobile roll compactor of claim 5, wherein:
the first link is turned by the arm actuator about an axis of rotation;
the second link is pivotally connected to the first link about a fourth pivot axis;
the second link is pivotally connected to the first arm about a fifth pivot axis; and
in the plurality of compacting configurations, the axis of rotation, the fourth pivot axis and the fifth pivot axis are aligned.

7. The mobile roll compactor of any one of claims 1 to 6, wherein the arm actuator and the roller actuator are rotary electric motors.

8. The mobile roll compactor of claim 7, further comprising a plurality of batteries connected to the frame for providing electric power to the rotary electric motors.

9. The mobile roll compactor of any one of claims 1 to 8, wherein the roller has a plurality of cutters.

10. The mobile roll compactor of any one of claims 1 to 9, wherein:
the ramp has a track; and
the roller has a sprocket for engaging the track as the roller rolls along the ramp.

11. The mobile roll compactor of claim 10, wherein:
the track has a plurality of longitudinally spaced apart and laterally extending pins; and
the sprocket has teeth for engaging the pins as the roller rolls along the ramp.

12. The mobile roll compactor of claim 11, wherein the teeth of the sprocket have an asymmetrical tooth profile.

13. The mobile roll compactor of any one of claims 1 to 12, wherein:
the ramp is two ramps; and
the first, second and third arms are laterally between the two ramps.

14. The mobile roll compactor of any one of claims 1 to 13, wherein the frame is a trailer frame of a trailer.

15. A method for compacting waste in an open top container with a mobile roll compactor, the mobile roll compactor having, a frame, a ramp connected to the frame, a roller, and an articulated arm assembly connecting the roller to the frame, the method comprising:
placing the mobile roll compactor next to the open top container;
rolling the roller up the ramp, the roller being rolled by a roller actuator operatively connected to the roller for turning the roller;
pivoting an arm of the articulated arm assembly from a generally horizontal position to a generally vertical position with an arm actuator, the arm having one end pivotally connected to the frame;
rolling the roller off the ramp;
rolling the roller over waste present in the open top container by rolling the roller with the roller actuator;
pivoting the arm of the articulated arm assembly from the generally vertical position to the generally horizontal position with the arm actuator, thereby moving the roller back onto the ramp; and
rolling the roller down the ramp by rolling the roller with the roller actuator.

16. The method of claim 15, wherein:
the arm is a first arm;
the articulated arm assembly further comprises:
a second arm pivotally connected to the first arm; and
a third arm pivotally connected to the second arm;
the roller is connected to the third arm;
the second arm is pivotally connected between the first and third arms;
the method further comprising:
limiting a minimum angle between one of:
the first and second arms; and
the second and third arms;
by using a stopper.

17. The method of claim 16, wherein:
limiting the minimum angle between one of:
the first and second arms; and
the second and third arms;
is limiting the minimum angle between the first and second arms;
the stopper is a first stopper connected to one of the first and second arms; and
the method further comprises limiting a minimum angle between the second and third arms by using a second stopper connected to one of the second and third arms.

18. The method of any one of claims 15 to 17, wherein:
rolling the roller up the ramp comprises engaging a sprocket of the roller with a track of the ramp; and
rolling the roller down the ramp comprises engaging the sprocket of the roller with the track of the ramp.

19. The method of any one of claims 15 to 18, wherein:
the mobile roll compactor has a trailer;
the frame is a trailer frame of the trailer; and
placing the mobile roll compactor next to the open top container comprises backing up the trailer next to the open top container.
